(19) United States
(12) Patent Application Publication
(10) Pub. No.: US 2019/0121717 A1
(43) Pub. Date: Apr. 25, 2019

(54) DYNAMIC, CROWD-SOURCED ERROR AND CRASH RESOLUTION FOR COMPUTER PROGRAMS

(71) Applicant: Microsoft Technology Licensing, LLC, Redmond, WA (US)

(72) Inventor: Robert B. Francis, Woodinville, WA (US)

(21) Appl. No.: 15/789,618

(22) Filed: Oct. 20, 2017

(51) Int. Cl. G06F 11/36

(52) U.S. Cl. CPC G06F 11/366; H04L 67/10; G06F 11/3664; G06F 11/3692

(57) ABSTRACT

Methods, systems, apparatuses, and computer program products are described herein that automatically determine when a computer program that is being executed on behalf of a user experiences an error condition or crash during execution of the computer program and that access, responsive to the determination, a data store to obtain one or more workarounds or fixes associated with the error condition or crash that have been previously submitted by one or more other users or developers of the computer program, and that present the one or more workarounds or fixes to the user of the computer program.

### BACKGROUND

In the software industry, some software publishers intermittently release software updates or patches that include fixes to problems with computer programs (e.g., applications and operating systems) that those publishers develop. The software updates may include fixes to correct security vulnerabilities and errors (e.g., software bugs) in a computer program, and/or improve the usability or performance of the computer program. Often, there is a time period after a problem with a computer program is discovered but before a fix or workaround to the problem has been developed and released as part of a software update. During this time period, a user of the computer program experiencing the problem will need to proactively seek a potential fix or workaround to the problem with the computer program. For example, the user may be required to contact a support line for the computer program or reference a frequently asked questions (FAQ) Web page or online support forum related to the computer program to obtain a potential fix or workaround for the problem with the computer program.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems, methods and computer program products are described herein that enable a user of a computer program to access workarounds or fixes associated with an error condition or crash detected at runtime. In embodiments, the workarounds or fixes may have been previously provided by other users and/or developers of the computer program, and the workarounds and fixes may be presented at or around the time the user experiences the error condition or crash. For example, in accordance with certain embodiments, an error handler is configured to determine when a computer program experiences an error condition or crash during execution of the computer program and to access, responsive to the determination, a data store to obtain one or more workarounds or fixes associated with the error condition or crash that have been previously submitted by one or more other users or developers of the computer program, and to present the one or more workarounds or fixes to the user of the computer program.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the application and, together with the description, further serve to explain the principles of the embodiment and to enable a person skilled in the relevant art(s) to make and use the embodiments.

FIG. 1 is a block diagram of an example system that enables a user of a computer program to access workarounds or fixes associated with an error condition or crash experienced by the computer program during execution thereof, in accordance with an embodiment.

FIG. 2 depicts a flowchart of a method for enabling a user of a computer program to access workarounds or fixes associated with an error condition or crash experienced by the computer program during execution thereof, according to an example embodiment.

FIG. 3 depicts a flowchart of a method for transmitting information associated with an error condition or crash, in accordance with an embodiment.

FIG. 4 depicts a flowchart of a method for providing a user with access to a solution submission user interface (UI) by which to submit one or more proposed workarounds or fixes, in accordance with an embodiment.

FIG. 5 is a block diagram of an example system that enables a user and/or a developer of a computer program to submit and/or access workarounds or fixes associated with an error condition or crash of the computer program, in accordance with an embodiment.

FIG. 6 depicts a flowchart of a method by which users can submit proposed workarounds or fixes associated with an error condition or crash of a computer program, in accordance with an embodiment.

FIG. 7 depicts a flowchart of a method by which a developer can provide a workaround or fix associated with an error condition or crash of a computer program to a data store, in accordance with an embodiment.

FIG. 8 illustrates an example solution submission UI, in accordance with an embodiment.

FIG. 9 is a block diagram of an example processor-based computer system that may be used to implement various embodiments.

The features and advantages of the embodiments described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. INTRODUCTION

The following detailed description discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of persons skilled in the relevant art(s) to implement such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. EXAMPLE EMBODIMENTS

Example embodiments described herein are directed to techniques that enable a user of a computer program to access workarounds or fixes associated with an error condition or crash detected at runtime. In accordance with certain embodiments, the workarounds or fixes may have been previously provided by other users and/or developers of the computer program, and the workarounds and fixes may be presented at the time the user experiences the error condition or crash.

As noted in the Background Section, above, in the software industry, some software publishers intermittently release software updates or patches that include fixes to problems with computer programs (e.g., applications and operating systems) that those publishers develop. The software updates may include fixes to correct security vulnerabilities and errors (e.g., software bugs) in a computer program, and improve the usability or performance of the computer program. Often, there is a time period after a problem with a computer program is discovered but before a fix or workaround to the problem has been developed and released as part of a software update. During this time period, a user of the computer program who experiences the problem will need to proactively seek a potential fix or workaround to the problem with the computer program. For example, the user may be required to contact a support line for the computer program or reference a frequently asked questions (FAQ) page or online support forum related to the computer program to obtain a potential fix or workaround for the problem with the computer program.

Some problems with the approach described above is that users may not remember what they were doing when they experienced a computer program problem or specific details that are needed to identify the problem. Moreover, some users may not have the insight into the inner workings of a computer program needed to identify a problem with a computer program. This approach also requires users to know where to find or how to obtain a fix or workaround to a known problem with a computer program. Some users may find seeking a fix or workaround to a problem with a computer program they are experiencing inconvenient and onerous.

Embodiments described herein address one or more of the above-mentioned issues by providing users of a computer program with workarounds or fixes associated with a runtime-detected error condition or crash. Such workarounds or fixes may have previously been submitted by other users and/or developers of the computer program. Such workarounds or fixes may also be presented to the user at or around the time the user experiences the error condition or crash. Such workarounds or fixes may be applied by the user without requiring a software update.

As used herein, the terms “workaround or fix” broadly refer to a solution to a problem experienced by a computer program at runtime. The solution may be obtained from a data store to which the computer program may be communicatively connected (e.g., via a network), and the data store may store the solution in in a variety of formats (e.g., in a database, as a single file, as a set of files). The solution may comprise, for example, text instructions, a link to a web page, or a set of commands the computer program would run locally on behalf of the user (e.g., through a batch file, Windows PowerShell, C#). However, these are examples only, and persons skilled in the relevant art(s) will appreciate that the solution may comprise any descriptive and/or computer executable information that can help the user resolve the problem with the computer program. The information provided to the user may also include additional metadata about the solution, including but not limited to who submitted the solution, when the solution was submitted, the version of the computer program for which the solution is relevant, an indication if a developer of the computer program verified the solution, and/or how many users claim the solution helped them.

As used herein, the term “error condition” generally refers to any error that takes place during the execution of a computer program (i.e., at runtime). An error condition may occur for a variety of reasons, including but not limited to invalid input data or adverse system parameters (e.g., a lack of sufficient memory to run a computer program or a memory conflict with another computer program). In some systems, if an error condition is detected, an error handler for a computer program may act to forestall errors and enable the computer program to recover without terminating, or (if all else fails) the error handler may gracefully terminate an affected computer program and save the error information to a log file. As used herein, the term “crash” generally refers to when a computer program stops functioning properly and exits. The crashing computer program may appear to hang until a crash reporting service reports the crash and any details relating to the crash.

In an embodiment, if a computer program experiences an error condition or crash, an error handler that is part of the computer program or that is associated therewith may access a known data store (e.g., a database) in which workarounds or fixes are stored and retrieve the workarounds or fixes that address the error condition or crash. A list of the workarounds or fixes may then be displayed to a user via a UI and the user may select from the list which workaround or fix to apply. In further accordance with such an embodiment, the user may be able to filter the workarounds or fixes by: who submitted the workarounds or fixes, when the workarounds or fixes were submitted, the version of the computer program for which the workarounds or fixes are relevant, how many users claim the workarounds or fixes helped them, the workarounds or fixes that were fully vetted by a developer, and/or other criteria. In at least one embodiment, for a newly-discovered error condition or crash, a user may select a “bleeding-edge” workaround or fix despite the workaround or fix not being fully vetted by a developer of the computer program. A listed workarounds or fix may also include computer-executable code that a user may run on her computing device. Furthermore, an indication of how many users have successfully used each of the one or more workarounds or fixes, or some other indicia of user approval or disapproval thereof may be presented to the user of the computer program.

In a still further embodiment, the workarounds or fixes may also be made fully visible to users so that the users can review and confirm that the workarounds or fixes do not include malicious content. If a user opts to not use any of the workarounds or fixes, the user may still save a report (e.g., a dump file) with enough information about the error condition or crash to uniquely identify the error condition or crash. In addition, if the user develops her own workaround or fix for the error condition or crash, the user can submit the workaround or fix via a UI, along with the report. This new workaround or fix may then be stored along with other workarounds or fixes so that other users can access the new workaround or fix. In another embodiment, a developer of the computer program can submit workarounds or fixes through a same or similar system and curate community-submitted workaround or fixes to ensure their accuracy and reliability.

Some advantages provided by embodiments described herein include but are by no means limited to: providing a solution to a problem with a computer program to a user at a time when the user experiences the problem; providing a solution to a problem with a computer program without requiring the execution of a software update; identifying a problem with a computer program that a user is experiencing without requiring the user to have insight into the inner workings of the computer program; and providing users with a precise mapping of an error condition or crash to one or more solutions.

The following provides a further description of methods, systems, apparatuses, and computer program products that enable a user of a computer program to access workarounds or fixes associated with a runtime-detected error condition or crash, wherein such workarounds or fixes may have been previously provided by other users and/or developers of the computer program, and wherein such workarounds or fixes may be presented to the user at or around the time when the user experiences the error condition or crash.

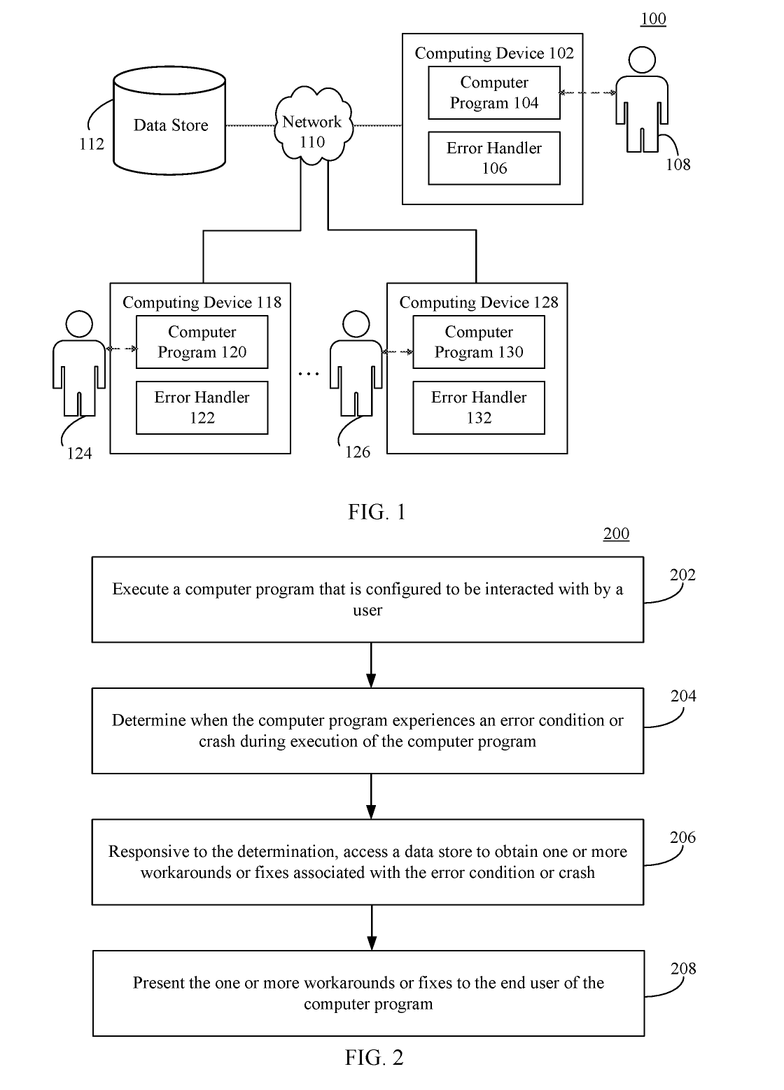

To help illustrate the foregoing, FIG. 1 will now be described. In particular, FIG. 1 is a block diagram of an example system 100 that enables a user of a computer program to access workarounds or fixes associated with an error condition or crash experienced by the computer program during execution thereof, in accordance with an embodiment. As shown in FIG. 1, system 100 includes a computing device 102, a computing device 118, a computing device 128, a network 110, and a data store 112. Computing device 102 includes a computer program 104 and an error handler 106, computing device 118 includes a computer program 120 and an error handler 122 and computing device 128 includes a computer program 130 and an error handler 132. Computer program 104, computer program 120 and computer program 130 are intended to represent different instances of the same computer program.

As shown in FIG. 1, network 110 communicatively connects each of computing device 102, computing device 118 and computing device 128 to data store 112. Although FIG. 1 shows only computing devices 102, 118 and 128 being communicatively connected to data store 112, any number of computing devices may be communicatively connected to data store 112 via network 110, including numbers of computing devices in the tens, hundreds, thousands, or greater numbers. System 100 is described in further detail as follows.

Computing devices 102, 118, and 128 may each comprise any type of stationary or mobile computing device. Examples of mobile computing devices include but are not limited to a Microsoft® Surface® device, a laptop computer, a notebook computer, a tablet computer such as an Apple iPad™, a netbook, a handheld gaming device, or a wearable computing device (e.g., a head-mounted device including smart glasses such as Google® Glass™, etc.). A stationary computing device may include but is not limited to a gaming console, a desktop computer, or a PC (personal computer).

Each of computing devices 102, 118, 128, may include at least one wired or wireless network interface that enables communication with data store 112 (or an intermediate device, such as a Web server or database server) via network 110. Examples of such a network interface include but are not limited to an IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, or a near field communication (NFC) interface. Examples of network 110 include a local area network (LAN), a wide area network (WAN), a personal area network (PAN), and/or a combination of communication networks, such as the Internet.

Computer programs 104, 120, and 130 may each comprise, for example, an instance of an application, an operating system, a suite of products, or products curated by an application (such as an integrated store/platform). In an embodiment in which computer programs 104, 120, and 130 each comprise an instance of an application, the application may comprise for example and without limitation a video game application, a productivity application (e.g., Microsoft® Word®, Microsoft® PowerPoint®, etc.), a database application (e.g., QuickBooks®, a Microsoft® Excel® spreadsheet), a social networking application, a messaging application (e.g., Microsoft® Outlook®), a financial services application, a news application, a search application, a cloud storage and/file hosting application, or the like.

In an embodiment, each of computer programs 104, 120, and 130 is installed and executed locally upon its corresponding computing device. In an alternate embodiment, each of computer programs 104, 120 and 130 may comprise instances of a network-based application, such as a Web or “cloud-based” application or service. In accordance with such an embodiment, computing device 102 may access computer program 104 over network 110, computing device 118 may access computer program 120 over network 110, and computing device 128 may access computer program 130 over network 110.

As further shown in FIG. 1, each of computer programs 104, 118 and 128 has an error handler associated therewith. In particular, computer program 104 has an error handler 106 associated therewith, computer program 120 has an error handler 122 associated therewith and computer program 130 has an error handler 132 associated therewith. Each error handler may comprise a part of its associated computer program. Alternatively, each error handler may be distinct from its associated computer program, but running on a same machine as the computer program. For example, the error handler may be part of an operating system and the computer program may comprise an application running on that operating system, although this example is not intended to be limiting.

Data store 112 may comprise one or more data storage devices or systems. Example data storage devices include but are not limited to a magnetic disc (e.g., in a hard disk drive), an optical disc (e.g., in an optical disk drive), a magnetic tape (e.g., in a tape drive), a RAM device, a ROM device, network-attached storage, or the like. Example data storage systems include but are not limited to a storage area network. Data may be stored in data store 112 in a variety of forms including but not limited to as databases and files.

Computer program 104 is configured to be interacted with by a user. For instance, a user 108 may interact with computer program 104 at computing device 102. Error handler 106 is configured to detect when computer program 104 experiences an error condition or crash during execution of computer program 104. Error handler 104 is further configured to, in response to detecting the error condition or crash, access data store 112 via network 110 to obtain therefrom one or more workarounds or fixes for the error condition or crash. In an embodiment, the one or more workarounds or fixes obtained from data store 112 may have been previously submitted by one or more other users or developers of computer program 104.

In a further embodiment, after error handler 106 has obtained the one or more workarounds or fixes from data store 112, error handler 106 may present the one or more workarounds or fixes to user 108 via a UI of computing device 102.

In a still further embodiment, error handler 106 may utilize at least one unique identifier associated with an error condition or crash to obtain the one or more workarounds or fixes from data store 112. For example, the unique identifier may comprise a string of characters assigned to the error condition or crash when the error condition or crash occurs. Such string of characters may be associated with an executed state of the computer program when the error condition or crash occurs. However, this example is not intended to be limiting and other types of unique identifiers may be used. Error handler 106 may provide the at least one unique identifier to data store 112 (or to a server or other entity that manages data store 112), and such unique identifier may be used thereby to obtain a corresponding set of workarounds or fixes. In other words, when a workaround or fix is stored in data store 112 for an error condition or crash, the workaround or fix is stored in association with at least one unique identifier of the error condition or crash. In this way, the workaround or fix can be accessed when an error handler (e.g., error handler 106) subsequently provides the unique identifier.

The foregoing description of computer program 104 and error handler 106 of computing device 102 is equally applicable to computer program 120 and error handler 122 of computing device 118 and to computer program 130 and error handler 132 of computing device 128. That is to say, error handler 122 may obtain from data store 112 workarounds or fixes for an error condition or crash of computer program 120 and present such workarounds or fixes to user 124 of computing device 118. Likewise, error handler 132 may obtain from data store 122 workarounds or fixes for an error condition or crash of compute program 130 and present such workarounds or fixes to user 126 of computing device 128.

As will be discussed in further detail herein, the workarounds or fixes stored in data store 112 may be submitted by other users or developers of the application to which the workarounds or fixes apply. Thus, by way of example, error handler 106 may present to user 108 of computing device 102 a workaround or fix for an error condition or crash that was submitted by user 124 of computing device 118 or by user 126 of computing device 128. Furthermore, as will also be discussed in further detail herein, error handler 106 may also present to user 108 an indicator along with a workaround or fix, wherein the indicator indicates that the workaround or fix was successfully or unsuccessfully used by one or more other users (e.g., one or more of user 124 or user 126) to address the relevant error condition or crash, was approved of or disapproved of by such users, or the like.

Thus, system 100 may operate in various ways to enable a user of a computer program to access workarounds or fixes associated with an error condition or crash experienced by the computer program during execution thereof. For instance, in embodiments, system 100 may operate according to FIG. 2. FIG. 2 depicts a flowchart 200 of a method for enabling a user of a computer program to access workarounds or fixes associated with an error condition or crash experienced by the computer program during execution thereof, according to an example embodiment. FIG. 2 will be described with continued reference to FIG. 1. However, other structural and operational embodiments will be apparent to persons skilled in the relevant art(s) based on the following discussion regarding flowchart 200 and system 100 of FIG. 1.

As shown in FIG. 2, the method of flowchart 200 begins at step 202. In step 202, a computer program that is configured to be interacted with by a user is executed. For example, and with continued reference to FIG. 1, computer program 104 that is configured to be interacted with by user 108 is executed at computing device 102.

At step 204, it is determined when the computer program experiences an error condition or crash during execution thereof. For example, and with continued reference to FIG. 1, error handler 106 may determine when the computer program 104 experiences an error condition or crash during execution of the computer program 104. In an embodiment, error handler 106 may assign a unique identifier (e.g., a string of characters) to the error condition or crash. For example, such unique identifier may be based on the executed state of the computer program when the error condition or crash occurs. However, this example is not intended to be limiting and other forms of unique identifiers may be used.

At step 206, responsive to the determination, a data store is accessed to obtain one or more workarounds or fixes associated with the error condition or crash. For example, and with continued reference to FIG. 1, responsive to the determination, error handler 106 may access data store 112 to obtain one or more workarounds or fixes associated with the error condition or crash of computer program 104. As will be discussed in more detail herein, such workarounds or fixes may have been previously submitted by one or more other users or developers of the computer program of which computer program 104 is an instance. For example, the one or more workarounds or fixes may have been previously submitted to data store 112 by user 124 and/or user 126 after user 124 and/or user 126 experienced the same error condition or crash.

At step 208, the one or more workarounds or fixes that were obtained during step 206 are presented to the user of the computer program. For example, and with continued reference to FIG. 1, error handler 106 may present the one or more workarounds or fixes to user 108 via a user interface of computing device 102.

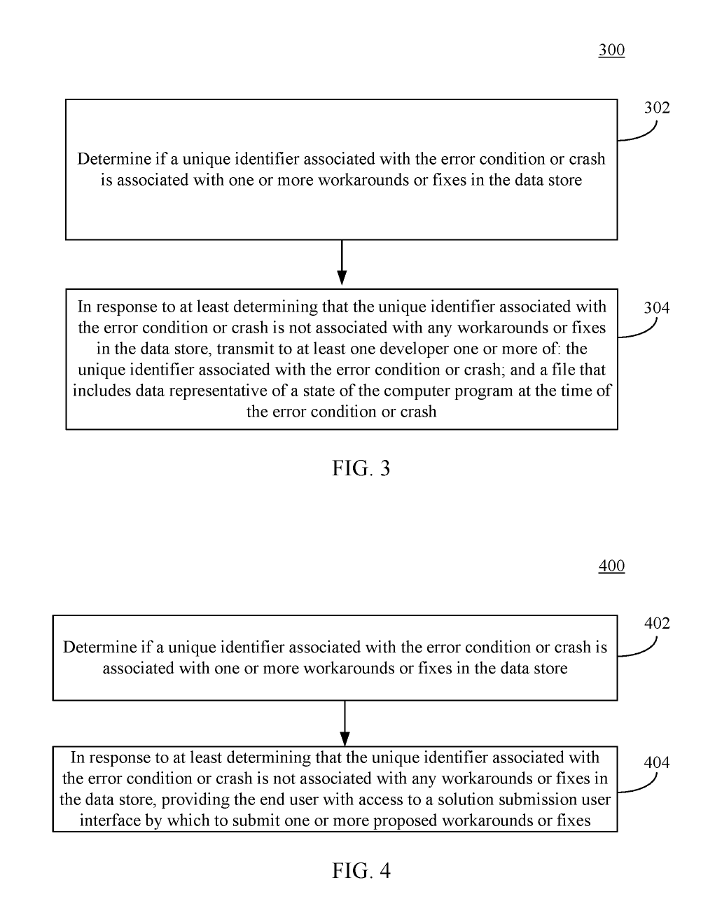

In certain embodiments, when an error handler (e.g., any of error handlers 106, 122 or 136) is not able to provide a user with a workaround or fix for a given error condition or crash, the error handler may cause information about the error condition or crash to be transmitted to a developer so that the developer can develop a workaround or fix for the error condition and crash and store it in data store 112. FIG. 3 depicts a flowchart 300 of a method for transmitting information associated with an error condition or crash in accordance with such an embodiment. FIG. 3 will be described with continued reference to FIG. 1. However, other structural and operational embodiments will be apparent to persons skilled in the relevant art(s) based on the following discussion regarding flowchart 300 and system 100 of FIG. 1.

As shown in FIG. 3, the method of flowchart 300 begins at step 302. In step 302, it is determined if a unique identifier associated with the error condition or crash is associated with one or more workarounds or fixes in the data store. For example, and with continued reference to FIG. 1, error handler 106 may determine if a unique identifier associated with the error condition or crash is associated with one or more workarounds or fixes in data store 112. As was previously noted, error handler 106 may assign a unique identifier to the error condition or crash when the error condition or crash occurs. Error handler 106 may then compare the assigned unique identifier to unique identifiers stored in data store 112.

At step 304, in response to at least determining that the unique identifier associated with the error condition or crash is not associated with any workarounds or fixes in the data store, one or more of the following are transmitted to at least one developer: the unique identifier associated with the error condition or crash and a file that includes data representative of a state of the computer program at the time of the error condition or crash. Transmission to a developer may comprise, for example, transmission to at least one computing device that is accessible by the developer. For example, and with continued reference to FIG. 1, in response to at least determining that the unique identifier associated with the error condition or crash is not associated with any workarounds or fixes in data store 112, error handler 106 may transmit to at least one developer one or more of: the one unique identifier associated with the error condition or crash of computer program 104 and a file that includes data representative of a state of computer program 104 at the time of the error condition or crash. At least one developer of computer program 104 may use the unique identifier and the file associated with the error condition or crash to develop a workaround or fix to the error condition or crash and submit the workaround or fix to be stored in data store 112.

In further embodiments, when an error handler (e.g., any of error handlers 106, 122 or 136) is not able to provide a user with a workaround or fix for a given error condition or crash, the error handler may provide the user with access to a solution submission interface by which to submit one or more proposed workarounds or fixes for the error condition or crash. FIG. 4 depicts a flowchart 400 of a method for providing a user with access to a solution submission UI by which to submit one or more proposed workarounds or fixes, in accordance with an embodiment. FIG. 4 will be described with continued reference to FIG. 1. However, other structural and operational embodiments will be apparent to persons skilled in the relevant art(s) based on the following discussion regarding flowchart 400 and system 100 of FIG. 1.

As shown in FIG. 4, the method of flowchart 400 begins at step 402. In step 402, it is determined if a unique identifier associated with the error condition or crash is associated with one or more workarounds or fixes in the data store. For example, and with continued reference to FIG. 1, error handler 106 may determine if a unique identifier associated with the error condition or crash is associated with one or more workarounds or fixes in data store 112. As was previously noted, error handler 106 may assign a unique identifier to the error condition or crash when the error condition or crash occurs. Error handler 106 may then compare the assigned unique identifier to unique identifiers stored in data store 112.

At step 404, in response to at least determining that the unique identifier associated with the error condition or crash is not associated with any workarounds or fixes in the data store, the end user is provided with access to a solution submission UI by which to submit one or more proposed workarounds or fixes. For example, and with continued reference to FIG. 1, in response to at least determining that the unique identifier associated with the error condition or crash is not associated with any workarounds or fixes in data store 112, error handler 106 may provide user 108 with access to a solution submission UI by which to submit one or more proposed workarounds or fixes. The solution submission UI may be provided via computing device 102 or some other computing device accessible to user 108. In an embodiment, user 108 may enter one or more proposed workarounds or fixes (e.g., comprising a set of commands or text describing steps to be performed) into a text entry box or some other user interactive control of the solution submission UI. Alternatively or additionally, in an embodiment, user 108 may upload a file that includes or is part of the one or more proposed workarounds or fixes through the solution submission UI.

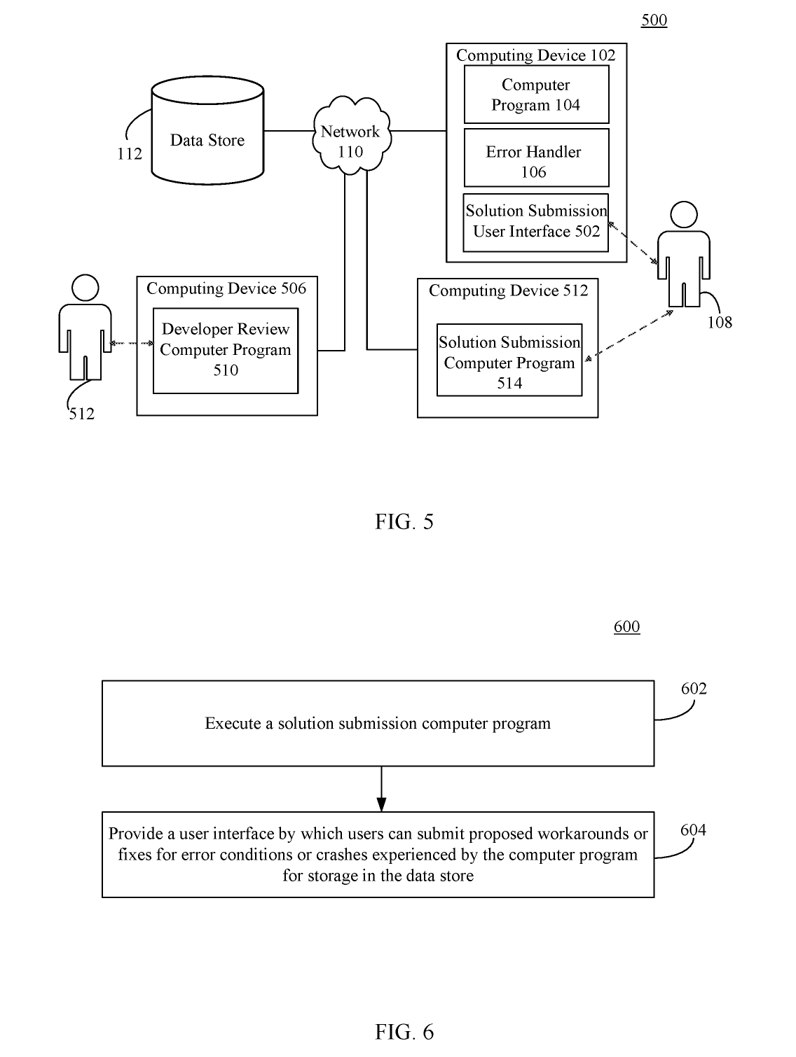

To further help illustrate the foregoing, FIG. 5 will now be described. In particular, FIG. 5 is a block diagram of an example system 500 that enables a user and/or a developer of a computer program to submit and/or access workarounds or fixes associated with an error condition or crash of the computer program, in accordance with an embodiment. As shown in FIG. 5, system 500 includes computing device 102, a computing device 506, a computing device 512, network 110 and data store 112. Computing device 102 (described in FIG. 1 above) further includes a solution submission user interface 502, computing device 506 includes a developer review computer program 510, and computing device 512 includes a solution submission computer program 514.

As shown in FIG. 5, network 110 communicatively couples computing each of computing device 102, computing device 506 and computing device 512 to data store 112. Although FIG. 5 shows only computing devices 502, 506 and 512 being communicatively connected to data store 112, any number of computing devices may be communicatively connected to data store 112 via network 110, including numbers of computing devices in the tens, hundreds, thousands, or greater numbers. System 500 is described in further detail as follows.

Computing devices 506 and 512 may be any of the types of computing devices described above with reference to computing devices 102, 118 and 128 of FIG. 1 and may include at least one network interface that enables communications over network 110. The network interface(s) may be any of the type described above in reference to computing device 102, 118 and 128.

Developer review computer program 510 at computing device 506 is configured to receive from computing device 102 via network 110 at least one of a unique identifier associated with an error condition or crash of computer program 104 and a file that includes data representative of a state of computer program 104 at the time of the error condition or crash. Developer review computer program 510 is further configured to make such unique identifier and/or file accessible to a developer 512 (e.g., via a UI of computing device 506), so that developer 512 can develop her own workaround or fix to the error condition or crash. Developer review computer program 510 is still further configured to receive a workaround or fix to the error condition or crash submitted by developer 512 and provide the at least one unique identifier associated with the error condition or crash and the developer-submitted workaround or fix to the error condition or crash to data store 112.

Moreover, developer review computer program 510 may also be configured to enable developer 512 to modify or remove a workaround or fix stored in data store 112. Developer 512 may modify or remove a workaround or fix based on a variety of factors, such as how effective the workaround or fix stored in data store 112 is in addressing an error condition or crash. As another example, developer 512 may remove a workaround or fix stored in data store 112 if the workaround or fix is determined to include malicious code. In yet another example, developer 512 may modify a workaround or fix stored in data store 112 if the workaround or fix includes unnecessary steps to address an error condition or crash.

As further shown in FIG. 5, a solution submission UI 502 may be provided (e.g., by error handler 106 or by some other component) at computing device 102. Solution submission UI provides a means by which user 108 can submit proposed workarounds or fixes for error conditions or crashes experienced by computer program 104 for storage in data store 112.

In particular, solution submission UI 502 at computing device 102 is configured to be interacted with by a user. For instance, user 108 may interact with solution submission UI 502 at computing device 102 to submit proposed workarounds or fixes via solution submission UI 502. For example, as described above, error handler 106 at computing device 102 is configured to detect when computer program 104 experiences an error condition or crash during execution of computer program 104. After detecting the error condition or crash, user 108 may be prompted via solution submission UI 502 to submit one or more proposed workarounds or fixes. In an embodiment, user 108 may enter one or more proposed workarounds or fixes (e.g., comprising a set of commands or text describing steps to be performed) into a text entry box or other user-interactive control of solution submission UI 502. Alternatively or additionally, in an embodiment, user 108 may upload a file that includes or is part of the one or more proposed workarounds or fixes through solution submission UI 502.

In an embodiment, solution submission UI 502 may be presented to user 108 in response to a determination by error handler 106 that a unique identifier associated with an error condition or crash is not associated with any workarounds or fixes in data store 112. In this manner, user 108 may be provided with solution submission UI 502 so that user 108 may submit one or more proposed workarounds or fixes associated with the unique identifier.

A user may submit a proposed workaround or fix to an error condition or crash of a computer program via a computing device that is different than the one on which the computer program experienced the error condition or crash. Thus, for example, as shown in FIG. 5, user 108 may also interact with solution submission computer program 514 executing on computing device 512 to submit a proposed workaround or fix to an error condition or crash experienced by computer program 104 while executing on computing device 102. Solution submission computer program 514 may operate to provide a solution submission UI that is similar to solution submission UI 502 as described above, so that user 108 can submit her workaround or fix.

In an embodiment, proposed workarounds or fixes submitted by users may be vetted, tested, or otherwise evaluated by a developer prior to the workaround or fix being entered into data store 112. For example, developer 512 may utilize developer review computer program 510 to evaluate a proposed workaround or fix submitted by user 108. After such evaluation, a proposed workaround or fix may be approved, in which case it can be entered into data store 112, or rejected, in which case it is not entered into data store 112. Such evaluation can be carried out by using manual methods, automated methods, or a combination of both.

In the foregoing description of FIG. 5, it is to be understood that each of computer program 104, error handler 106, and solution submission UI 502 may be installed and executed on computing device 112, developer review computer program 510 may be installed and executed on computing device 506, and solution submission computer program 514 may be installed and executed on computing device 512. Alternatively, one or more of computer program 104, error handler 106, solution submission UI 502, developer review computer program 510 and solution submission computer program 514 may comprise a network-based application or service that is accessed via network 110.

Thus, system 500 may operate in various ways to enable a user and/or a developer of a computer program to submit and/or access workarounds or fixes associated with an error condition or crash of the computer program, in accordance with an embodiment. For instance, in embodiments, system 500 may operate according to FIG. 6. FIG. 6 depicts a flowchart 600 of a method by which users can submit proposed workarounds or fixes associated with an error condition or crash of a computer program, in accordance with an embodiment. FIG. 6 will be described with continued reference to FIG. 5. However, other structural and operational embodiments will be apparent to persons skilled in the relevant art(s) based on the following discussion regarding flowchart 600 and system 500 of FIG. 5.

As shown in FIG. 6, the method of flowchart 600 begins at step 602. In step 602, a solution submission computer program is executed. For example, and with continued reference to FIG. 5, solution submission computer program 514 at computing device 512 is executed.

At step 604, a user interface is provided by which users can submit proposed workarounds or fixes for error conditions or crashes experienced by a computer program for storage in a data store. For example, and with continued reference to FIG. 5, solution submission computer program 514 at computing device 512 provides a solution submission UI by which user 108 can submit proposed workarounds or fixes for error conditions or crashes experienced by computer program 104 for storage in data store 112.

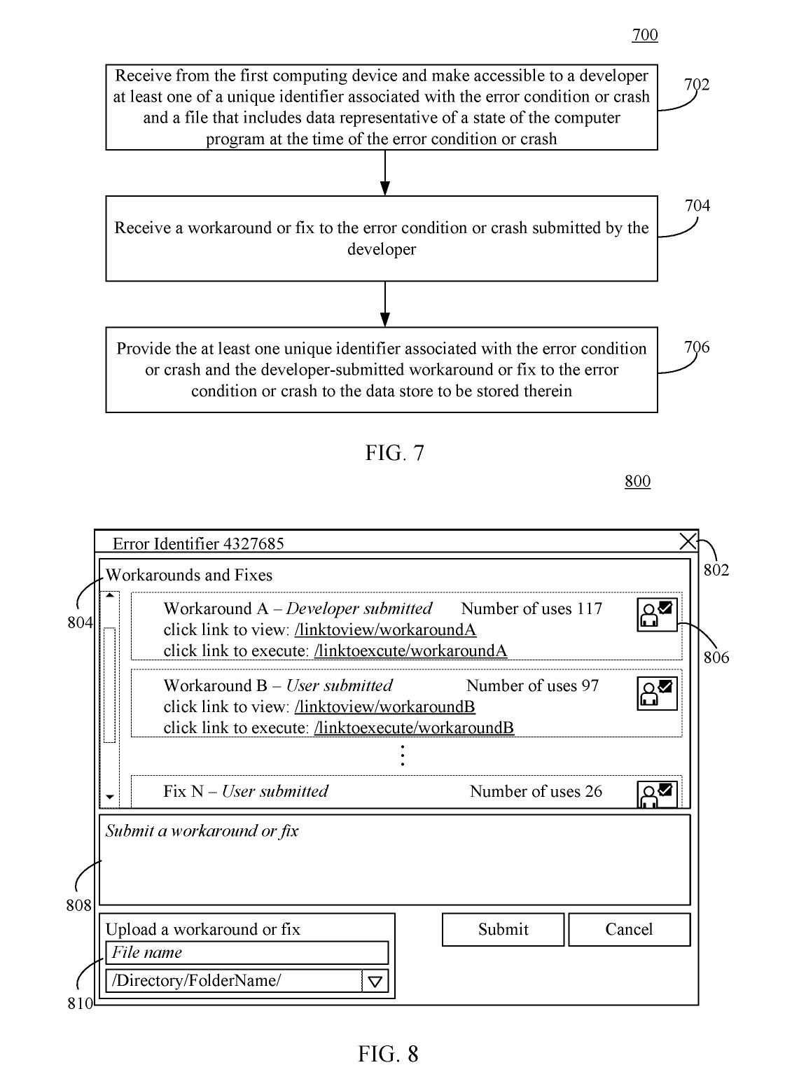

In further embodiments, system 500 may operate according to FIG. 7. FIG. 7 depicts a flowchart 700 of a method by which a developer provides a workaround or fix associated with an error condition or crash of a computer program to a data store, in accordance with an embodiment. FIG. 7 will be described with continued reference to FIG. 5. However, other structural and operational embodiments will be apparent to persons skilled in the relevant art(s) based on the following discussion regarding flowchart 700 and system 500 of FIG. 5.

As shown in FIG. 7, the method of flowchart 700 begins at step 702. In step 702, at least one of the following is received from a first computing device and made accessible to a developer: a unique identifier associated with an error condition or crash of a computer program and a file that includes data representative of a state of the computer program at the time of the error condition or crash. For example, and with continued reference to FIG. 5, developer review computer program 510 may receive from computing device 506 and make accessible to developer 506 at least one of a unique identifier associated with an error condition or crash of computer program 104 and a file that includes data representative of a state of computer program 104 at the time of the error condition or crash.

At step 704, a workaround or fix to the error condition or crash that is submitted by the developer is received. For example, and with continued reference to FIG. 5, developer review computer program 510 at computing device 506 may receive a workaround or fix to the error condition or crash submitted by developer 512.

At step 706, the at least one unique identifier associated with the error condition or crash and the developer-submitted workaround or fix to the error condition or crash is provided to the data store to be stored therein. For example, and with continued reference to FIG. 5, developer review computer program 510 may provide the at least one unique identifier associated with the error condition or crash and the developer-submitted workaround or fix to the error condition or crash to data store 112 to be stored therein. A solution submission UI (such as solution submission UI 502 or a solution submission UI provided by solution submission computer program 514) may be configured in any suitable manner, and may include one or more suitable user interface controls or elements to input, display and submit workarounds or fixes associated with an error condition or crash. By way of example, FIG. 8 shows an example solution submission UI 800, according to an example embodiment. Solution submission user interface 800 may comprise an example of solution submission user interface 502.

As shown in FIG. 8, solution submission user interface 800 includes a title bar 802 that identifies a unique identifier for an error condition or crash, “Error Identifier 4327685”. Solution submission user interface 800 further includes a section 804 titled “Workarounds and Fixes”. Section 804 displays a list of workarounds and fixes associated with the error condition or crash, “Error Identifier 4327685”. A user of solution submission user interface 800 may scroll through the list of workarounds and fixes displayed in section 804 to view information related to each workaround and fix in the list. As shown in FIG. 8, the information related to each workaround or fix in the list displayed in section 804 includes the title of the workaround or fix, whether the workaround or fix was developer or user submitted, the number of times a user used the workaround or fix, and links to view and execute the workaround or fix. For example, “Workaround A” of the list of section 804 is developer submitted and has been used a by users 117 times. In addition, a user of solution submission user interface 800 may indicate successfully using Workaround A by clicking on an interactive element 806 (e.g., a button). In FIG. 8, each workaround or fix in the list displayed in section 804 includes an interactive element for a user to indicate success in using the corresponding workaround or fix. In accordance with various embodiments, the user may also be able to filter the workarounds or fixes by one or more of: who submitted the workarounds or fixes, when the workarounds or fixes were submitted, the version of the computer program the workarounds or fixes are relevant for, how many users claim the workarounds or fixes helped them, and the workarounds or fixes that were fully vetted by a developer.

As shown in FIG. 8, solution submission user interface 800 also includes a text entry box 808 and a file upload entry box 810. A user may enter one or more proposed workarounds or fixes (e.g., comprising a set of commands or text describing steps to be performed) into text entry box 808 or upload a file depicting the one or more proposed workarounds or fixes through file upload entry box 810.

### III. EXAMPLE COMPUTER SYSTEM IMPLEMENTATION

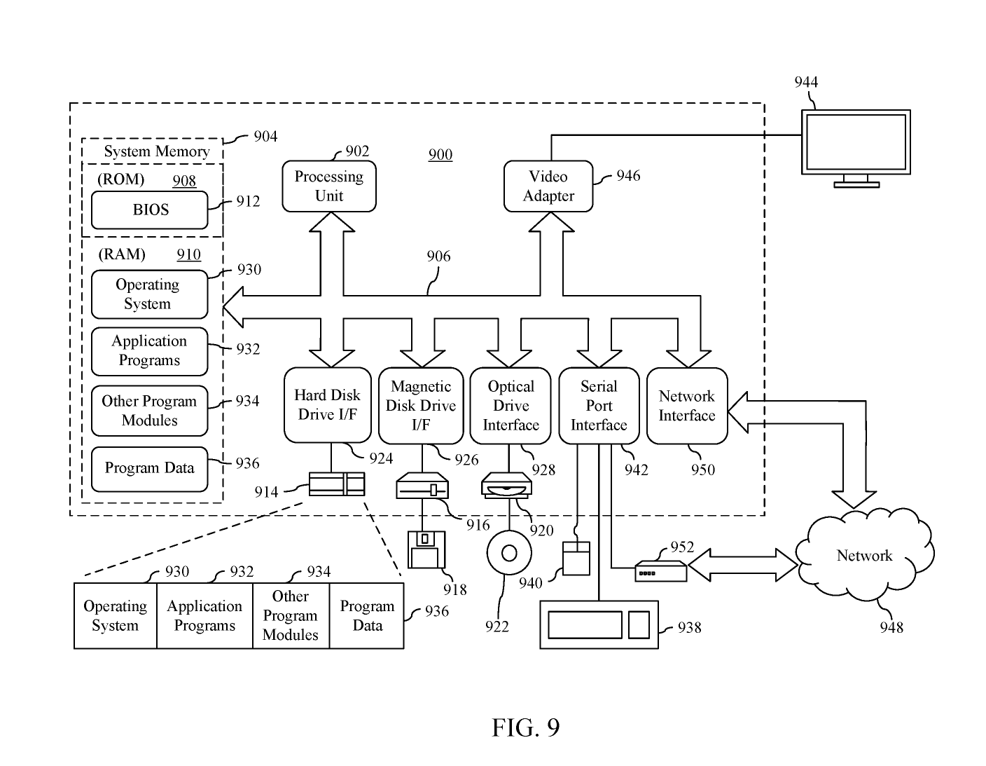

FIG. 9 depicts an example processor-based computer system 900 that may be used to implement various embodiments described herein, such as any of the embodiments described in the Sections above and in reference to FIGS. 1-8. For example, processor-based computer system 900 may be used to implement any of the components of system 100 and system 500 as described above in reference to FIGS. 1 and 5 as well as any of the flowcharts described above in reference to FIGS. 2-4, 6, and 7. The description of system 900 provided herein is provided for purposes of illustration, and is not intended to be limiting. Embodiments may be implemented in further types of computer systems, as would be known to persons skilled in the relevant art(s).

As shown in FIG. 9, system 900 includes a processing unit 902, a system memory 904, and a bus 906 that couples various system components including system memory 904 to processing unit 902. Processing unit 902 may comprise one or more processing circuits, such as hardware-implemented microprocessors or microprocessor cores. Bus 906 represents one or more of any of several types of bus structures, including a memory bus or memory controller, a peripheral bus, an accelerated graphics port, and a processor or local bus using any of a variety of bus architectures. System memory 904 includes read only memory (ROM) 908 and random access memory (RAM) 910. A basic input/output system 912 (BIOS) is stored in ROM 908.

System 900 also has one or more of the following drives: a hard disk drive 914 for reading from and writing to a hard disk, a magnetic disk drive 916 for reading from or writing to a removable magnetic disk 918, and an optical disk drive 920 for reading from or writing to a removable optical disk 922 such as a CD ROM, DVD ROM, BLU-RAY™ disk or other optical media. Hard disk drive 914, magnetic disk drive 916, and optical disk drive 920 are connected to bus 906 by a hard disk drive interface 924, a magnetic disk drive interface 926, and an optical drive interface 928, respectively. The drives and their associated computer-readable media provide nonvolatile storage of computer-readable instructions, data structures, program modules and other data for the computer. Although a hard disk, a removable magnetic disk and a removable optical disk are described, other types of computer-readable memory devices and storage structures can be used to store data, such as flash memory cards, digital video disks, random access memories (RAMs), read only memories (ROM), and the like.

A number of program modules may be stored on the hard disk, magnetic disk, optical disk, ROM, or RAM. These program modules include an operating system 930, one or more application programs 932, other program modules 934, and program data 936. In accordance with various embodiments, the program modules may include computer program logic that is executable by processing unit 902 to implement any of the embodiments described in the Sections above and in reference to FIGS. 1-8. For example, the program modules may include computer program logic that is executable by processing unit 902 to implement any of the components of system 100 and 500 as described above in reference to FIGS. 1 and 5 as well as any of the flowcharts described above in reference to FIGS. 2-4, 6, and 7.

A user may enter commands and information into system 900 through input devices such as a keyboard 938 and a pointing device 940 (e.g., a mouse). Other input devices (not shown) may include a microphone, joystick, game controller, scanner, or the like. In one embodiment, a touch screen is provided in conjunction with a display 944 to allow a user to provide user input via the application of a touch (as by a finger or stylus for example) to one or more points on the touch screen. These and other input devices are often connected to processing unit 902 through a serial port interface 942 that is coupled to bus 906, but may be connected by other interfaces, such as a parallel port, game port, or a universal serial bus (USB). Such interfaces may be wired or wireless interfaces.

Display 944 is connected to bus 906 via an interface, such as a video adapter 946. In addition to display 944, system 900 may include other peripheral output devices (not shown) such as speakers and printers.

System 900 is connected to a network 948 (e.g., a local area network or wide area network such as the Internet) through a network interface 950, a modem 952, or other suitable means for establishing communications over the network. Modem 952, which may be internal or external, is connected to bus 906 via serial port interface 942.

As used herein, the terms “computer program medium,” “computer-readable medium,” and “computer-readable storage medium” are used to generally refer to memory devices or storage structures such as the hard disk associated with hard disk drive 914, removable magnetic disk 918, removable optical disk 922, as well as other memory devices or storage structures such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media

As noted above, computer programs and modules (including application programs 932 and other program modules 934) may be stored on the hard disk, magnetic disk, optical disk, ROM, or RAM. Such computer programs may also be received via network interface 950, serial port interface 942, or any other interface type. Such computer programs, when executed or loaded by an application, enable system 900 to implement features of embodiments discussed herein. Accordingly, such computer programs represent controllers of the system 900.

Embodiments are also directed to computer program products comprising software stored on any computer usable medium. Such software, when executed in one or more data processing devices, causes a data processing device(s) to operate as described herein. Embodiments may employ any computer-usable or computer-readable medium, known now or in the future. Examples of computer-readable mediums include, but are not limited to memory devices and storage structures such as RAM, hard drives, floppy disks, CD ROMs, DVD ROMs, zip disks, tapes, magnetic storage devices, optical storage devices, MEMs, nanotechnology-based storage devices, and the like.

### IV. ADDITIONAL EXAMPLE EMBODIMENTS

A computing device is described herein that comprises at least one processor, and memory accessible by the at least one processor, the memory storing computer program logic for execution by the at least one processor, the computer program logic comprising: a computer program that is configured to be interacted with by a user; an error handler that is configured to determine when the computer program experiences an error condition or crash during execution of the computer program and, responsive to the determination, to access a data store to obtain one or more workarounds or fixes associated with the error condition or crash that have been previously submitted by one or more other users of the computer program, and to present the one or more workarounds or fixes to the user of the computer program.

In an embodiment of the foregoing computing device, the computer program is one of an operating system or an application.

In another embodiment of the foregoing computing device, the one or more workarounds or fixes that have been previously submitted by the one or more other users are submitted via a solution submission user interface.

In yet another embodiment of the foregoing computing device, the error handler utilizes at least one unique identifier associated with the error condition or crash to obtain the one or more workarounds or fixes.

In still another embodiment of the foregoing computing device, the error handler is configured to: determine if a unique identifier associated with the error condition or crash is associated with one or more workarounds or fixes in the data store; and in response to at least determining that the unique identifier associated with the error condition or crash is not associated with any workarounds or fixes in the data store, transmit to at least one developer one or more of: the unique identifier associated with the error condition or crash; and a file that includes data representative of a state of the computer program at the time of the error condition or crash.

In a further embodiment of the foregoing computing device, the error handler is configured to: determine if a unique identifier associated with the error condition or crash is associated with one or more workarounds or fixes in the data store; and in response to at least determining that the unique identifier associated with the error condition or crash is not associated with any workarounds or fixes in the data store, provide the end user with access to a solution submission user interface by which to submit one or more proposed workarounds or fixes.

In a still further embodiment of the foregoing computing device, the error handler is further configured to present an indication of how many other users have successfully used each of the one or more workarounds or fixes that are presented to the user of the computer program.

In another embodiment of the foregoing computing device, the data store is accessed by the error handler via a network.

In yet another embodiment, the one or more workarounds or fixes presented to the user includes code that is executable by the end user.

A system is also described herein that includes a first computing device that is configured to execute: a computer program that is configured to be interacted with by a user; and an error handler that is configured to determine when the computer program experiences an error condition or crash during execution of the computer program, to access, responsive to the determination, a data store to obtain one or more workarounds or fixes associated with the error condition or crash that have been previously submitted by one or more other users of the computer program, and to present the one or more workarounds or fixes to the user of the computer program.

In an embodiment of the foregoing system, the system further comprises a second computing device that is configured to execute a solution submission computer program, the solution submission computer program being configured to provide a user interface by which users can submit proposed workarounds or fixes for error conditions or crashes experienced by the computer program for storage in the data store.

In another embodiment of the foregoing system, the error handler presents multiple workarounds or fixes to the end user of the computer program, wherein at least one of the workarounds or fixes is presented along with an indication of a number of other users that approve of the workaround or fix.

In yet another embodiment of the foregoing system, the system further comprises a second computing device that executes a developer review computer program, the developer review computer program being configured to receive from the first computing device and make accessible to a developer at least one of a unique identifier associated with the error condition or crash and a file that includes data representative of a state of the computer program at the time of the error condition or crash, to receive a workaround or fix to the error condition or crash submitted by the developer, and to provide the at least one unique identifier associated with the error condition or crash and the developer-submitted workaround or fix to the error condition or crash to the data store to be stored therein. In further accordance with this embodiment, the developer review computer program is further configured to enable the developer to modify or remove a workaround or fix stored in the data store based on how effective the workaround or fix stored in the data store is in addressing an error condition or crash.

A method is also described herein that comprises: executing a computer program that is configured to be interacted with by an end user; determining when the computer program experiences an error condition or crash during execution of the computer program; responsive to the determination, accessing a data store to obtain one or more workarounds or fixes associated with the error condition or crash that have been previously submitted by one or more other users of the computer program; and presenting the one or more workarounds or fixes to the end user of the computer program.

In an embodiment of the foregoing method, the computer program is one of an operating system or an application.

In another embodiment of the foregoing method, the one or more workarounds or fixes that have been previously submitted by the one or more other users are submitted via a solution submission user interface.

In yet another embodiment of the foregoing method, the method further comprises:

determining if a unique identifier associated with the error condition or crash is associated with one or more workarounds or fixes in the data store; and in response to at least determining that the unique identifier associated with the error condition or crash is not associated with any workarounds or fixes in the data store, transmit to at least one developer one or more of: the unique identifier associated with the error condition or crash; and a file that includes data representative of a state of the computer program at the time of the error condition or crash.

In still another embodiment of the foregoing method, the method further comprises: determining if a unique identifier associated with the error condition or crash is associated with one or more workarounds or fixes in the data store; and in response to at least determining that the unique identifier associated with the error condition or crash is not associated with any workarounds or fixes in the data store, providing the user with access to a solution submission user interface by which to submit one or more proposed workarounds or fixes.

In a further embodiment of the foregoing method, the method further comprises presenting an indication of how many users have successfully used each of the one or more workarounds or fixes that are presented to the user of the computer program.

### V. CONCLUSION

While various embodiments have been described above, it should be understood that they have been presented by way of example only, and not limitation. It will be apparent to persons skilled in the relevant art(s) that various changes in form and details can be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A computing device, comprising:
at least one processor; and
memory accessible by the at least one processor, the memory storing computer program logic for execution by the at least one processor, the computer program logic comprising:
a computer program that is configured to be interacted with by a user;
an error handler that is configured to determine when the computer program experiences an error condition or crash during execution of the computer program and, responsive to the determination, to access a data store to obtain one or more workarounds or fixes associated with the error condition or crash that have been previously submitted by one or more other users of the computer program or crash, and to present the one or more workarounds or fixes to the user of the computer program.

2. The computing device of claim 1, wherein the computer program is one of an operating system or an application.

3. The computing device of claim 1, wherein the one or more workarounds or fixes that have been previously submitted by the one or more other users are submitted via a solution submission user interface.

4. The computing device of claim 1, wherein the error handler utilizes at least one unique identifier associated with the error condition or crash to obtain the one or more workarounds or fixes.

5. The computing device of claim 1, wherein the error handler is configured to:
determine if a unique identifier associated with the error condition or crash is associated with one or more workarounds or fixes in the data store; and
in response to at least determining that the unique identifier associated with the error condition or crash is not associated with any workarounds or fixes in the data store, transmit to at least one developer one or more of:
the unique identifier associated with the error condition or crash; and
a file that includes data representative of a state of the computer program at the time of the error condition or crash.

6. The computing device of claim 1, wherein the error handler is configured to:
determine if a unique identifier associated with the error condition or crash is associated with one or more workarounds or fixes in the data store; and
in response to at least determining that the unique identifier associated with the error condition or crash is not associated with any workarounds or fixes in the data store, provide the user with access to a solution submission user interface by which to submit one or more proposed workarounds or fixes.

7. The computing device of claim 1, wherein the error handler is further configured to present an indication of how many other users have successfully used each of the one or more workarounds or fixes that are presented to the user of the computer program.

8. The computing device of claim 1, wherein the data store is accessed by the error handler via a network.

9. The computing device of claim 1, wherein the one or more workarounds or fixes presented to the user includes code that is executable by the user.

10. A system comprising,
a first computing device that is configured to execute:
a computer program that is configured to be interacted with by a user; and
an error handler that is configured to determine when the computer program experiences an error condition or crash during execution of the computer program, to access, responsive to the determination, a data store to obtain one or more workarounds or fixes associated with the error condition or crash that have been previously submitted by one or more other users of the computer program, and to present the one or more workarounds or fixes to the user of the computer program.

11. The system of claim 10, further comprising:
a second computing device that is configured to execute a solution submission computer program, the solution submission computer program being configured to provide a user interface by which users can submit proposed workarounds or fixes for error conditions or crashes experienced by the computer program for storage in the data store.

12. The system of claim 11, wherein the error handler presents multiple workarounds or fixes to the user of the computer program, wherein at least one of the workarounds or fixes is presented along with an indication of a number of other users that approve of the workaround or fix.

13. The system of claim 10, further comprising:
a second computing device that executes a developer review computer program, the developer review computer program being configured to receive from the first computing device and make accessible to a developer at least one of a unique identifier associated with the error condition or crash and a file that includes data representative of a state of the computer program at the time of the error condition or crash, to receive a workaround or fix to the error condition or crash submitted by the developer, and to provide the at least one unique identifier associated with the error condition or crash and the developer-submitted workaround or fix to the error condition or crash to the data store to be stored therein.

14. The system of claim 13, wherein the developer review computer program is further configured to enable the developer to modify or remove a workaround or fix stored in the data store based on how effective the workaround or fix stored in the data store is in addressing an error condition or crash.

15. A method, comprising:
executing a computer program that is configured to be interacted with by a user;
determining when the computer program experiences an error condition or crash during execution of the computer program;
responsive to the determination, accessing a data store to obtain one or more workarounds or fixes associated with the error condition or crash that have been previously submitted by one or more other users of the computer program; and
presenting the one or more workarounds or fixes to the end user of the computer program.

16. The method of claim 15, wherein the computer program is one of an operating system or an application.

17. The method of claim 15, wherein the one or more workarounds or fixes that have been previously submitted by the one or more other users opers are submitted via a solution submission user interface.

18. The method of claim 15, further comprising:
determining if a unique identifier associated with the error condition or crash is associated with one or more workarounds or fixes in the data store; and
in response to at least determining that the unique identifier associated with the error condition or crash is not associated with any workarounds or fixes in the data store, transmitting to at least one developer one or more of:
the unique identifier associated with the error condition or crash; and
a file that includes data representative of a state of the computer program at the time of the error condition or crash.

19. The method of claim 15, further comprising:
determining if a unique identifier associated with the error condition or crash is associated with one or more workarounds or fixes in the data store; and
in response to at least determining that the unique identifier associated with the error condition or crash is not associated with any workarounds or fixes in the data store, providing the user with access to a solution submission user interface by which to submit one or more proposed workarounds or fixes.

20. The method of claim 15, further comprising presenting an indication of how many other users have successfully used each of the one or more workarounds or fixes that are presented to the user of the computer program.
